(19) United States
(12) Patent Application Publication
(10) Pub. No.: US 2005/0093302 A1
(43) Pub. Date: May 5, 2005

(54) Vibration-to-electric energy generator and method of same

(76) Inventors: Masayuki Miyazaki, Tokyo (JP); Kazuki Watanabe, Tokyo (JP); Hiroshi Toyama, Tokyo (JP)

Correspondence Address: REED SMITH LLP;Suite 1400, 3110 Fairview Park Drive, Falls Church, VA, 22042, US

(21) Appl. No.: 10/894,048

(22) Filed: Jul. 20, 2004

(30) Foreign Application Priority Data
Oct. 29, 2003 (JP) 2003-368305

(51) Int. Cl. H02P 9/04; F42B 3/16; F42C 11/00; F42C 19/12

(52) U.S. Cl. 290/1 R

(57) ABSTRACT

A vibration-to-electric energy generator using a resonant variable capacitor (RVC) which converts vibration energy to electric energy in an environment where any kind of vibration may occur, the generator can generate electricity optimally and adaptive to change in frequency, amplitude, and phase of vibration energy. The generator includes RVC, initial charge assurance circuit, start and halt circuit, reference clock generator, pulse generation circuit, charge transportation circuit, and output control circuit. The initial charge assurance circuit and start and halt circuit control and save the conditions of electricity generating operation. The reference clock generator and pulse generation circuit generate reference signal and timing control signals in sync with vibration energy applied to the generator. By timing control signals, the charge transportation circuit charges and discharges the RVC, thus generating electric energy. The output control circuit stabilizes generated electric power.

### CLAIM OF PRIORITY

The present application claims priority from Japanese application JP 2003-368305 filed on Oct. 29, 2003, the content of which is hereby incorporated by reference into this application as if set forth herein in the entirety.

### FIELD OF THE INVENTION

The present invention relates to a vibration-to-electric energy generator that converts vibration energy to electric energy, and, more particularly, to a vibration-to-electric energy generator that uses a resonant variable capacitor having a fluctuating capacitance that fluctuates in resonance with the vibration energy.

### BACKGROUND OF THE INVENTION

Conventional vibration-to-electric energy conversion using variable capacitors include a charge pump that increases a voltage level by using a variable capacitor (for example, see The Japan Society of Mechanical Engineers, Collected Papers (Part C), Vol. 65, No. 634, 1999, pp. 268-275), and the generating of electric energy by charging/discharging of a variable capacitor (for example, see IEEE Transactions on Very Large Scale Integration Systems, vol. 9, no. 1, 2001, pp. 64-75).

In the computing era, semiconductor IC chips may be deployed throughout public places to issue and gather information. For the semiconductor IC chips so used in this manner, it is ideal that the use of such is permanent once installed. Thus, an extremely low operating power of a semiconductor IC and a complete curtailing of the chip maintenance cost are required. One conceivable of accomplishing thse goals is the reducing of the electricity consumption of a chip to a low level to prolong the life span of the power supply to the chip, such as a battery cell, for driving the chip. Instead of the battery cell, it would be preferable to use energy existing in the natural world to enable the chip to operate semi-permanently. In utilizing such natural energy for the power source of a chip, diverse methods have been suggseted, including: a solar cell using solar light energy; an RF (radio frequency) coil power source using electromagnetic wave energy; a Seebeck effect device using temperature difference; an electromagnetic induction power source using vibration energy; a piezo device power source; a variable-capacitor-type power source; and a fuel cell using gas, among others. Solar cell, RF coil power source, generating electricity by temperature difference, and fuel cell require a supply of external energy. Generating electricity using vibration energy similarly needs vibration energy that is supplied externally, however, minute vibration existing in the natural world, and great vibration produced by human beings, equipment, and other moving things, can provide a constant source of vibration energy. Therefore, there is a high probability that vibration energy can be used as a power source in any place and environment. Several methods for converting vibration energy to electric energy are available, including: electromagnetic induction power using a coil and magnet; generating electricity using a piezo device; and generating electricity using a variable capacitor. Each of these methods, each, with the exception of the variable capacitor method, need specific material (a magnetic material and ceramic). However, to implement the variable capacitor type, a conductor to form capacitance and a vibrator that can resonate with vibration energy are the only essentials. Therefore, the variable capacitor type is advantageous in that variable capacitors are easy to mass produce and low in cost.

In vibration-to-electric energy generation using a resonant variable capacitor, one of two electrodes which form the variable capacitor vibrates with vibration energy, and the other electrode resonates with the vibration energy, and, via springs, generates greater vibration. As the electrodes vibrate, the distance between the electrodes changes and, accordingly, the capacitance fluctuates. By charging and discharging in synchronization with the capacitance fluctuation, electric energy is generated. This is a principle of generating electricity by vibration-to-electric energy generation using a resonant variable capacitor.

There are two types of vibration-to-electric energy conversion using a variable capacitor. One is the charge pump method which increases a voltage level by using the variable capacitor, such as by, for example, the method described in the above cited The Japan Society of Mechanical Engineers, Collected Papers (Part C), Vol. 65, No. 634, 1999, pp. 268-275. This method uses the capacitance fluctuation due to vibration energy to increase the voltage, and another power source as the source of the voltage if needed. Thus, this is not a pure vibration-to-electric energy generator. Another method which generates electricity by charging/discharging of the variable capacitor is the method described in the above cited IEEE Transactions on Very Large Scale Integration Systems, vol. 9, no. 1, 2001, pp. 64-75. In a device in which capacitance fluctuates in resonance with vibration energy, a charge transportation circuit supplies charge to the variable capacitor at the moment when the capacitance has reached the maximum. After that, when the capacitance drops to the minimum, the voltage across the capacitor rises as much as the fluctuation in the capacitance. At the moment when the capacitance has become the minimum, by releasing the charge from the variable capacitor through the charge transportation circuit, electricity equivalent to the voltage rise is generated. In an example given in the above-cited paper, the variable capacitor is formed as a Micro Electronic Mechanical System (MEMS). Because the MEMS can be generated by a process that is used to produce semiconductor ICs, the MEMS variable capacitor is easy to manufacture and its size is easy to reduce.

If the vibration-to-electric energy generator using the resonant variable capacitor is used as the power supply for semiconductor IC chips, a mechanism of generating electricity adaptive to natural vibration is necessary. Specifically, the mechanism has to adapt to change to the amplitude, frequency, and phase of vibration.

In a typical variable-capacitor-type vibration-to-electric energy converter, as discussed above, control signals in sync with both the cycle and phase of vibration energy must be generated. Consequently, to synchronize the cycle, an external clock in sync with a designed value of resonant cycle of the resonating variable capacitor is used. However, the use of the external clock is not adaptable to an out-of-phase resonant cycle, due to variable capacitor manufacturing variance and transient change in vibration energy.

A phase optimization method, in which electricity output is supplied to a ring oscillator and controlled to increase its oscillation rate, my be used to address this issue. However, this method causes much output electricity to be consumed in the ring oscillator. To avoid electricity consumption, the method may be modified to use the ring oscillator for phase setting only for an initialization time, and not to use the ring oscillator for subsequent operation. However, this is not adaptable to a phase shift due to change in the amplitude of vibration energy. The amplitude of vibration energy determines the maximum and minimum capacitances of the resonating variable capacitor. It is essential for generating electricity that the amplitude of vibration energy, or the difference between maximum and minimum capacitances of the variable capacitor, is not less than a certain value. If the amplitude or difference falls below that value, then the initial charge will be lost and it will be impossible to perform electricity generating operation indefinitely. It is thus not possible for the relevant art to generate electricity through vibration-to-electricity conversion in an optimum manner adaptive to possible changes in the amplitude, cycle, and phase of vibration energy that occor in natural vibration.

FIG. 2 is a schematic diagram of a vibration-to-electric energy generator using the resonant variable capacitor of relevant art. A block “Load & Control” in FIG. 2 consists of a load that uses electricity output and a circuit to generate signals for on/off control of the switching MOS transistors SW1, SW2. By controlling the turn on/off of the switching MOS transistors SW1, SW2 in accordance with capacitance fluctuation of the variable capacitor, electricity can be generated.

FIG. 3 is a diagram showing waveforms representing the electricity generating operation of the vibration-to-electric energy generator using the resonant variable capacitor of relevant art. In FIG. 3, one waveform i1 represents an inductor current and the other waveform vm represents potential in proportion to charge that is stored in the resonating variable capacitor CMEMS. At the start of operation, or during operation, initial voltage or steady voltage vdd exists at the electricity output point vc. In other words, charge corresponding to the above voltage is stored in the storage capacitor CRES. As vibration energy is applied to the resonating variable capacitor CMEMS, the variable capacitor' capacitance fluctuates at the same frequency as the vibration frequency. At the moment when the capacitance has reached the maximum (hereinafter referred to as Cmax), the MOS transistor SW2 turns on and the inductor L and the storage capacitor form a first LC resonance circuit which allows the charge at the vc point to flow into the inductor L for a period t1 in FIG. 3. When the inductor current i1 has reached the maximum, the MOS transistor SW2 turns off and the MOS transistor SW1 turns on. As a result, the inductor L and the capacitors CMEMS and CPAR form a second LC resonance circuit which supplies energy stored in the inductor to the resonating variable capacitor CMEMS for a period t2 in FIG. 3 during which voltage vm rises. When the inductor current i1 stops, the MOS transistor SW2 turns off. The charge injected into the variable capacitor CMEMS is preserved. Then, the capacitance of the resonating variable capacitor CMEMS changes from Cmax to the minimum (hereinafter referred to as Cmin). During this change, the amount of charge of the capacitor CMEMS is a constant value QO. Because there is a relation Q0=CMEMS capacitance×voltage vm, as the capacitance of the capacitor CMEMS changes from Cmax to Cmin, the voltage vm increases from the minimum voltage vmin to the maximum voltage vmax for a period t3 in FIG. 3. When the capacitance of the resonating variable capacitor CMEMS has dropped to Cmin by vibration, the charge stored in the capacitor CMEMS is discharged to the electricity output point vc by reversing the above procedure triggered by Cmax. That is, the MOS transistor SW1 first turns on, and the inductor L and the capacitor CMEMS form the second LC resonance circuit which allows current to flow across the inductor L for a period t4 in FIG. 3. When the inductor current i1 has reached the maximum, the MOS transistor SW1 turns off and the SW2 turns on. Then, the inductor L and the storage capacitor CRES form the first LC resonance circuit which delivers energy stored in the inductor L to the storage capacitor CRES for a period t5 in FIG. 3. The cycle in which the capacitance of the resonating variable capacitor CMEMS fluctuates is the same as the vibration cycle of vibration energy; i.e., a time interval of 100 ms to 0.1 ms corresponding to, approximately, several tens of hertz to several kilohertz. On the other hand, the on period of either of the MOS transistors (t1, t2, t4, t5 in FIG. 3) is on the order of several hundred nanoseconds, smaller by three digits or more. Thus, during the on period of either of the MOS transistors, the capacitance of the variable capacitor CMEMS may be regarded as being constant at Cmax or Cmin. With regard to the inductor current i1 waveform in FIG. 3, for the periods t1 and t2, electric power is consumed to supply charge to the capacitor CMEMS, whereas, for the periods t4 and t5, when the voltage of the capacitor CMEMS has reached the maximum, the capacitor is discharged and electricity is generated. Assuming an ideal condition of 100% efficiency, the vibration-to-electric energy generator produces electric energy:
E=(Cmax−Cmin)*vmax*vmin/2

FIG. 4 is a schematic showing a resonator of relevant art using micro-machined technology (hereinafter referred to as MEMS (Micro-Electronic Mechanical System)). As the resonating variable capacitor CMEMS, the resonator structure of relevant art shown in FIG. 4 may be used. The MEMS can be produced by a typical silicon process technology of semiconductor ICs. Still combs SC11, SC12 are fixed on a silicon substrate and function as opposing electrodes of the variable capacitor. Vibration mass PM11 supported by free beams FB11 is anchored to the silicon substrate by anchors AN11. By the spring action of the free beams FB11, the vibration mass PM 11 vibrates at a resonance frequency over the silicon wafer. Vibration energy shakes the silicon wafer and the still combs SC11, SC12, and the anchors A11 fixed to the wafer and the vibration mass PM11 resonate with the vibration energy, thereby vibrating at greater amplitude than the silicon wafer. Given that the vibration mass PM11 is an electrode, capacitance is formed between the vibration mass and the still comb SC11 or SC12. The capacitance reaches the maximum when the mass comes closest to the still comb SC11 and drops to the minimum when the mass goes farthest from the still comb. Capacitance between the still comb SC12 and the mass PM11 changes in a phase opposite to the phase of the capacitance between the still comb SC11 and the mass PM11. As the capacitance of the resonating variable capacitor, either one of these capacitances may be used. The cycle in which the capacitance fluctuates is identical to the cycle of the vibration energy.

In the vibration-to-electric energy generator using the resonant variable capacitor of relevant art discussed above with reference to FIGS. 2, 3, and 4, electric energy to be generated depends on the amplitude of fluctuation of the capacitance of the resonating variable capacitor CMEMS, and the accuracy of pulse width, cycle, and phase of timing control signals swp/swn which control the turn on/off of the switching MOS transistors SW1, SW2, which determines the efficiency of electricity output. Because there are restrictions of the resonance frequency and the amplitude of capacitance fluctuation, the use of a transducer or resonator other than the MEMS may be needed for some capacitor types using vibration energy.

Thus, the need exists for a vibration to energy converter that is desensitized to changes in vibration amplitude, frequency, or phase, and that provides robust self-powering for an indefinitely long time period.

### SUMMARY OF THE INVENTION

Thus, the present invention provides a vibration-to-electric energy generator that generates electricity through vibration-to-electricity conversion in an optimum manner, which is flexibly adaptive to change in frequency, amplitude, and phase conditions in natural vibration. The vibration-to-electric energy generator includes an initial charge assurance circuit, a start and halt circuit, a reference clock generator, a pulse generation circuit, and an output control circuit in order to make use of a vibration-to-electric energy generator using the resonating variable capacitor and the charge transportation circuit provided by relevant art.

The present invention may also provide a vibration-to-electric energy generator in which the initial charge assurance circuit enables the generator to start operation and, after the generator operation halts in circumstances where vibration energy does not exist or exists but it is too small to generate electricity, the generator restarts to operate when it is supplied with sufficient vibration energy again.

The present invention may also provide a vibration-to-electric energy generator in which the start and halt circuit starts of the generator, in an environment where the magnitude of vibration energy or the amplitude of vibration is not less than a certain level and is sufficient to generate electricity, halts the generator under conditions where vibration energy is not enough to generate electricity, and in which the generator accurately determines timing to synchronize with vibration phases when the generator starts, and in which the generator operation halts when the amount of generated electricity is small, thus preventing the charge stored in its output portion from being consumed idly.

The present invention may also provide the vibration-to-electric energy generator in which the reference clock generator functions to obtain synchronization with the cycle (frequency) of vibration energy with accuracy, dispensing with an external clock.

The present invention may also provide the vibration-to-electric energy generator in which the pulse generation circuit monitors output electricity and performs phase alignment of pulse signals for control of the charge transportation circuit, in order to optimize the output electricity, and wherein the generator performs optimum control even if the conditions of vibration energy change during operation.

The present invention may also provide the vibration-to-electric energy generator in which the output control circuit stabilizes electric energy and the charge transportation circuit produces and allocates the electricity to small electric power use and large electric power use, so that the electric power generated by vibration-to-electricity conversion is stably consumed.

A vibration-to-electric energy generator of the present invention may include an initial charge assurance circuit, a start and halt circuit, a reference clock generator, a pulse generation circuit, a charge transportation circuit, a resonating variable capacitor, and an output control circuit. The initial charge assurance circuit notifies the start and halt circuit that initial charge enough to start the generator exists by sending an initial-charge signal to that circuit, and supplies the initial charge to the charge transportation circuit. The start and halt circuit decides to start or halt the generator from the initial-charge signal and a vibration amplitude signal of vibration energy that is applied to the resonating variable capacitor, determines timing to start, based on a reference signal, and supplies a start and halt signal to the pulse generation circuit. The reference clock generator receives the vibration amplitude signal of vibration energy that is applied to the resonating variable capacitor, generates a reference signal in sync with vibration energy and at the same frequency as the vibration, and supplies the reference signal to the pulse generation circuit. Based on the reference signal, the pulse generation circuit generates timing control signals for control of the charge transportation circuit in sync with the start and halt signal timing. Using an output power signal from the charge transportation circuit, the pulse generation circuit makes phase adjustments of the timing signals. Using the timing control signals and based on the initial-charge signal supplied from the initial charge assurance circuit, the charge transportation circuit produces electricity and generates a generated power signal. Capacitance of the vibrating variable capacitor fluctuates in resonance with its ambient vibration energy. The output control circuit stabilizes the generated power signal from the charge transportation circuit, optimally allocates the output power, and supplies two types of outputs, one for large electric power use and the other for small electric power use. The thus configured generator can generate electricity through vibration-to-electricity conversion in an optimum manner flexibly adaptive to change in frequency, amplitude, and phase which are conditions for using natural vibration.

More specifically, the vibration-to-electric energy generator of the present invention may include an initial charge assurance circuit which outputs first and second initial-charge signals, the start and halt circuit which receives inputs of the second initial-charge signal, a vibration amplitude signal, and a reference signal, and outputs a start and halt signal, the reference clock generator which receives an input of the vibration amplitude signal and outputs the reference signal, the pulse generation circuit which receives inputs of the start and halt signal, the reference signal, and an output power signal, and outputs first and second timing control signals, a charge transportation circuit which receives inputs of the first initial-charge signal, the first and second timing control signals, and first and second capacitance signals, and outputs the vibration amplitude signal, the output power signal, and a generated power signal, and the resonating variable capacitor which outputs the first and second capacitance signals, and the output control circuit which receives an input of the generated power signal and outputs first and second output signals. The output control circuit delivers electric power which is obtained in such a manner that the resonating variable capacitor converts vibration energy applied to it to electric energy.

The initial charge assurance circuit supplies initial electric power that is essential for the vibration-to-electric energy generator to start electricity generating operation to the vibration-to-electric energy generator. The initial charge assurance circuit may include a power supply, a switch, and a comparator circuit; the electric power of the power supply is supplied via the switch to the vibration-to-electric energy generator as the first initial-charge signal; and the comparator circuit outputs the second initial-charge signal, if the electric power of the power supply is not less than the electric power required to drive the vibration-to-electric energy generator.

The start and halt circuit may start or halt the electricity generating operation of the vibration-to-electric energy generator and generates the start and halt signal. The start and halt circuit may include a vibration amplitude measurement circuit and a start timing control circuit; the vibration amplitude measurement circuit measures the amplitude of vibration that is applied to the resonating variable capacitor and decides to start or halt the electricity generating operation, according to the measured amplitude of the vibration; and the start timing control circuit generates a command to start or halt the electricity generating operation as decided by the vibration amplitude measurement circuit as the start and halt signal in phase with the phase of the vibration.

The reference clock generator may generate a clock signal in sync with the cycle of vibration that is applied to the resonating variable capacitor as the reference signal. The pulse generation circuit may generate the timing control signals for control of the charge transportation circuit in sync with the reference signal. The pulse generation circuit may include at least one delay control circuit and logic circuits; and the phases and pulse widths of the timing control signals are arbitrarily controllable. The pulse generation circuit may include an output power measurement circuit; the output power measurement circuit measures the magnitude of electric power of the output power signal and generates a timing control command to optimize the electric power; and the delay control circuit optimally controls its delay time under the control of the timing control circuit to optimize the electric power of the generated power signal which the charge transportation circuit generates. The output control signal may stabilize the generated power signal which the charge transportation circuit generates and may deliver the first and second output signals, according to the electric power, and the frequency for electric power usage. The output control circuit stabilizes the generated power signal to keep the level of voltage at a certain value or below, accumulates first electric power output for a first period and almost constantly outputs the first electric power output as the first output signal, and accumulates second electric power output, larger than the first electric power output, for a second period which is longer than the first period, and intermittently outputs the second electric power output as the second output signal.

The vibration-to-electric energy generator of the present invention may include a plurality of the resonating variable capacitors with different resonance frequencies; and one of the resonating variable capacitors which delivers greatest electric energy by converting vibration energy applied to the resonating variable capacitors to electric energy is selected to maximize generated electric power in accordance with the frequency and magnitude of the vibration energy.

In order to make good use of the vibration-to-electric energy generator using the resonating variable capacitor and the charge transportation circuit provided by relevant art in a natural vibration environment, the vibration-to-electric energy generator according to the present invention is configured to include the initial charge assurance circuit, start and halt circuit, reference clock generator, pulse generation circuit, and output control circuit. Its advantage resides at least in that it can generate electricity through vibration-to-electricity conversion in an optimum manner flexibly adaptive to changes in frequency, amplitude, and phase which occur in natural vibration.

The vibration-to-electric energy generator according to the present invention includes the initial charge assurance circuit that enables the generator to start operation. An advantage resides in that, after the generator operation halts in circumstances where vibration energy does not exist or exists but it is too small to generate electricity, the generator can restart to operate when it comes to be supplied with sufficient vibration energy again.

The vibration-to-electric energy generator according to the present invention allows the start and halt circuit to start the generator in an environment where the magnitude of vibration energy or the amplitude of vibration is not less than a certain level and sufficient to generate electricity, and to halt the generator under conditions where vibration energy is not enough to generate electricity. An advantage resides in that the generator accurately determines timing to synchronize with vibration phases when the generator starts and halts its operation when the amount of generated electricity is small, thus preventing the charge stored in its output portion from being consumed idly.

The vibration-to-electric energy generator according to the present invention allows the reference clock generator to function to obtain synchronization with the cycle (frequency) of vibration energy with accuracy, dispensing with an external clock.

The vibration-to-electric energy generator according to the present invention allows the pulse generation circuit to monitor output electricity and perform phase alignment of pulse signals for control of the charge transportation circuit in order to optimize (increase) the output electricity. The generator can perform optimum control even if the conditions of vibration energy change during operation.

The vibration-to-electric energy generator according to the present invention allows the output control circuit to stabilize electric energy that the charge transportation circuit produces and to allocate the electricity to small electric power use and large electric power use, so that the electric power generated by vibration-to-electricity conversion can be stably consumed.

Thus, the present invention provides a vibration to energy converter that is desensitized to changes in vibration amplitude, frequency, or phase, and that provides robust self-powering for an indefinitely long time period.

### BRIEF DESCRIPTION OF THE DRAWINGS

FIG. 1 is a block diagram of an embodiment of the vibration-to-electric energy generator;

FIG. 2 is a schematic diagram of a relevant art example of a vibration-to-electric energy generator;

FIG. 3 shows waveforms representing the operation of the relevant art example of the vibration-to-electric energy generator;

FIG. 4 is a schematic of a relevant art example of a resonating variable capacitor;

FIG. 5 is a schematic of an embodiment of an initial charge assurance circuit;

FIG. 6 is a schematic of an embodiment of the initial charge assurance circuit;

FIG. 7 is a schematic of an embodiment of a start and halt circuit;

FIG. 8 is a waveform chart representing the operation of the start and halt circuit;

FIG. 9 is a schematic of an embodiment of the start and halt circuit;

FIG. 10 is a schematic of an embodiment of the start and halt circuit;

FIG. 11 is a schematic of an embodiment of the start and halt circuit;

FIG. 12 is a schematic of an embodiment of a reference clock generator;

FIG. 13 is a waveform chart representing the operation of the reference clock generator;

FIG. 14 is a schematic of an embodiment of the reference clock generator;

FIG. 15 is a waveform chart representing the operation of an embodiment of the reference clock generator;

FIG. 16 is a schematic of an embodiment of the reference clock generator;

FIG. 17 is a schematic of an embodiment of the reference clock generator;

FIG. 18 is a schematic of an embodiment of a pulse generation circuit;

FIG. 19 is a waveform chart representing the operation of the pulse generation circuit;

FIG. 20 is a schematic of an embodiment of a delay control circuit;

FIG. 21 is a schematic of an embodiment of the delay control circuit;

FIG. 22 is a waveform chart representing the operation of the delay control circuit;

FIG. 23 is a schematic of an embodiment of the pulse generation circuit;

FIG. 24 is a schematic of an embodiment of the pulse generation circuit;

FIG. 25 is a schematic of an embodiment of a phase adjustment device for the pulse generation circuit;

FIG. 26 is a schematic of an embodiment of the phase adjustment device for the pulse generation circuit;

FIG. 27 is a schematic of an embodiment of an output control circuit;

FIG. 28 is a waveform chart representing the operation of the output control circuit;

FIG. 29 is a schematic of an embodiment of a device for variable vibration energy;

FIG. 30 is a schematic of an embodiment of a nonvolatile memory; and

FIG. 31 is a schematic of an embodiment of a system with the power generator.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical semiconductor devices, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

According to an embodiment of the present invention, an initial charge assurance circuit supplies initial electric power that is essential for the vibration-to-electric energy generator using a resonant variable capacitor to start electricity generating operation.

According to an embodiment of the present invention, the initial charge assurance circuit includes a power supply, a switch, and a comparator circuit. Electric power of the power supply is supplied via the switch to the vibration-to-electric energy generator using a resonant variable capacitor. The comparator circuit determines whether the electric power of the power supply maintains the level of electric power required to start to drive the vibration-to-electric energy generator, and sends an initial-charge signal to the start and halt circuit.

According to an embodiment of the present invention, a start and halt circuit decides to start or halt the electricity generating operation of the vibration-to-electric energy generator using a resonant variable capacitor, and outputs a start and halt signal.

According to an embodiment of the present invention, the start and halt circuit includes a vibration amplitude measurement circuit and a start timing control circuit. The vibration amplitude measurement circuit measures the magnitude of vibration energy that is applied to the resonating variable capacitor and decides to start or halt the electricity generating operation, according to the amplitude of the vibration. As a result, the start timing control circuit outputs a start and halt signal at optimum timing in sync with the phase of the vibration.

According to an embodiment of the present invention, the reference clock generator supplies a clock signal in sync with the vibration cycle of vibration energy that is applied to the resonating variable capacitor as a reference signal.

According to an embodiment of the present invention, the pulse generation circuit receives a reference signal input, makes phase and pulse width adjustments of the reference signal, and outputs timing control signals for control of the charge transportation circuit.

According to an embodiment of the present invention, the pulse generation circuit includes a plurality of delay control circuits and logic circuits. The phase and pulse width of the reference signal that the pulse generation circuit receives are arbitrarily controlled by the delay control circuits, and the reference signal is converted to timing control signals to be output.

According to an embodiment of the present invention, the pulse generation circuit includes an output power measurement circuit which measures the electric power with regard to an output power signal of electricity output that the charge transportation circuit produces and generates a timing control command to maximize or optimize the output electric power. The delay control circuits receive this timing control command and generate timing control signals with an optimum delay or pulse width which are supplied to the charge transportation circuit.

According to an embodiment of the present invention, the output control circuit stabilizes generated power signals which are generated by the charge transportation circuit and delivers two types of output signals, according to the electric power and the frequency for electric power usage.

According to an embodiment of the present invention, the output control circuit keeps the level of voltage at a certain value or below when stabilizing the generated power signal. To distribute the two types of output signals, the output control circuit has two output ports: one which accumulates small electric power output for a short period and always outputs the electric power; and the other which accumulates large electric power output for a long period and outputs the electric power at regular intervals.

According to an embodiment of the present invention, the vibration-to-electric energy generator includes a plurality of resonating variable capacitors with different resonance frequencies and optimizes electric energy to be generated by selecting one of the variable capacitors that is most resonating with the frequency of vibration energy applied to the resonating variable capacitors. This device is adaptable to varying vibration frequencies of vibration energy.

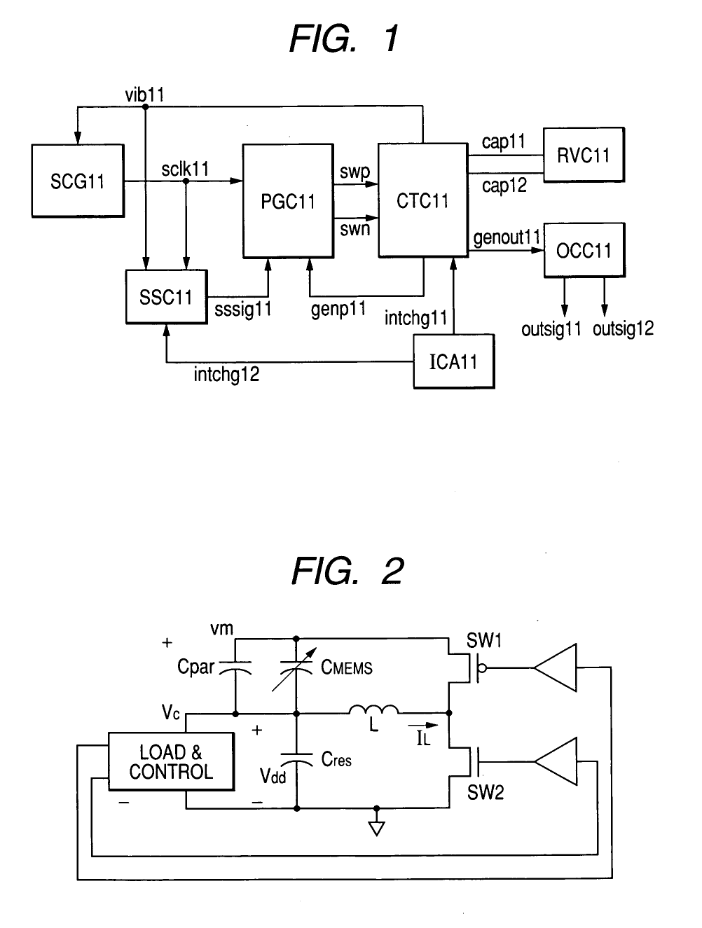

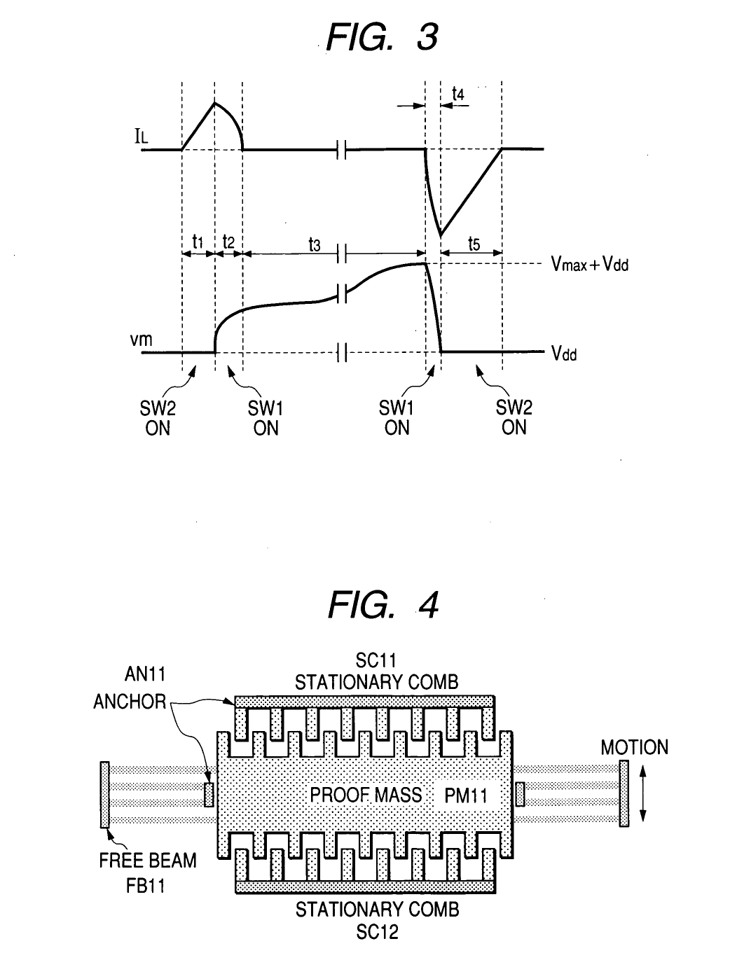

FIG. 1 is a block diagram showing an embodiment of the vibration-to-electric energy generator according to the invention. The vibration-to-electric energy generator of the present invention includes a resonating variable capacitor RVC11 which forms variable capacitance, using vibration energy, a charge transportation circuit CTC11 which converts vibration energy to electric energy by charging/discharging the variable capacitor, and an initial charge assurance circuit ICA11, a start and halt circuit SSC11, a reference clock generator SCG11, a pulse generation circuit PGC11, and an output control circuit OCC11 which controls the operation of the charge transportation circuit CTC11. The initial charge assurance circuit ICA11 outputs initial-charge signals intchg11 and intchg12. The start and halt circuit SSC11 receives the inputs of an initial-charge signal intchg12, a reference signal sclk11, and a vibration amplitude signal vib11, and outputs a start and halt signal sssig11. The reference clock generator SCG11 receives the input of the vibration amplitude signal vib11 and outputs the reference signal sclk11. The pulse generation circuit PGC11 receives the inputs of the reference signal sclk11, start and halt signal sssig, and an output power signal genp11, and outputs timing control signals swp and swn. The charge transportation circuit CTC11 receives the inputs of the timing control signals swp/swn and initial-charge signal intchg11 and outputs the vibration amplitude signal vib11, output power signal genp11, and a generated power signal genout11, and capacitance signal cap11/cap12 paths are connected to it. The output control circuit OCC11 receives the input of the generated power signal genout11 and outputs output signals outsig11/outsig12. To the resonating variable capacitor RVC11, the capacitance signal cap11/cap12 paths are connected.

Fundamental operation of a vibration-to-electric energy converter using the variable capacitor was presented hereinabove. The components necessary for the fundamental operation are the charge transportation circuit CTC11 and resonating variable capacitor RVC11 among the components shown in FIG. 1, and a control circuit of the charge transportation circuit.

The vibration-to-electric energy generator embodiment of the present invention of FIG. 1 represents the vibration-to-electric energy generator using the resonant variable resistor that resolves the above-discussed problem of the relevant art, and that is able to convert any given vibration energy, like natural vibration, to electric energy efficiently. For the vibration-to-electric energy generator using the resonant variable resistor, initial charge must exist in the output portion genout11 of the CTC11 when the operation starts. The initial charge is also essential for restarting the operation after the electricity generating operation halts; without the initial charge, it is impossible to generate electricity. When the electricity generating operation starts, the initial charge assurance circuit supplies the initial charge to the power output portion genout11 of the CTC11 by sending the initial-charge signal intchg11 to the CTC11, notifies the start and halt circuit that the initial charge exists by sending the initial-charge signal intchg12 to that circuit, and enables the generator to start the electricity generating operation. The initial charge is also necessary for the start and halt circuit SSC11, reference clock generator SCG11, and pulse generation circuit PGC11 when the electricity generating operation starts, and the initial charge assurance circuit ICAL11 supplies the electric power to these components by sending the initial-charge signal intchg11 to them. When the start and halt circuit SSC11 receives both the initial-charge signal intchg12, which indicates that sufficient initial charge exists when the generator operation starts, and the vibration amplitude signal vib11, which indicates that there is sufficient vibration amplitude or amplitude of capacitance fluctuation of the resonating variable capacitor to perform electricity generating operation, it supplies the start and halt signal sssig11.

During electricity generating operation, when the vibration energy decreases and the amplitude of vibration becomes not enough to generate electricity, the vibration amplitude signal vib11 decreases accordingly, and the start and halt circuit stops supplying the start and halt signal sssig11 to stop the electricity generating operation. Electricity generating operation must start with transporting the initial charge from the power output portion genout11 of the CTC11 to the variable capacitor when the capacitance the resonating variable capacitor RVC11 has reached the maximum. Therefore, the timing of the start and halt signal sssig11 to start the operation is adjusted so that the reference signal sclk11 will be sent to the pulse generation circuit PGC11 while the capacitance of the resonating variable capacitor RVC11 changes from the minimum to the maximum. In other words, the reference signal sclk11 generated by the reference clock generator SCG11 is effectively used as a clock signal within the pulse generation circuit PGC11 only after the start and halt signal sssig11 generated by the start and halt circuit SSC11 is supplied, and the timing when the start and halt signal sssig11 is supplied must come during the transition from the minimum to the maximum of the capacitance of the resonating variable capacitor RVC11. The reference clock generator SCG11 receives the vibration amplitude signal vib11 corresponding to capacitance fluctuation of the resonating variable capacitor RVC11 from the charge transportation circuit CTC11, generates a clock signal with the same cycle as the cycle of the capacitance fluctuation, and outputs this signal as the reference signal sclk11. The oscillating frequency of the reference signal sclk11 agrees with the frequency at which the capacitance of the resonating variable capacitor RVC11 fluctuates, but coincidence in phase and duty cycle is not always required.

When getting the start and halt signal sssig11, the pulse generation circuit PGC11 generates the timing control signals swp, swn for control of the charge transportation circuit CTC11, using the reference signal sclk1. The cycle in which these timing control signals swp□swn oscillate corresponds to the cycle of the reference signal sclk11; that is, it corresponds to the cycle in which the capacitance of the resonating variable capacitor RVC11 fluctuates, or in other words, the cycle of vibration energy that is given to the generator. The pulse generation circuit PGC11 is given a signal, the output power signal genp11, in accordance with the amount of electric power of the generated power signal genout11 corresponding to electricity the charge transportation circuit CTC11 produces. Based on this signal, the pulse widths and phases of the timing control signals swp, swn are adjusted optimally. After the charge transportation circuit CTC11 gets the timing control signals swp, swn, the charge transportation circuit CTC11 carries out the electricity generating operation in conjunction with the resonating variable capacitor RVC11 via the capacitance signals cap 11, cap 12 in the same manner as described for the relevant art in the background section. The charge transportation circuit CTC11 receives the capacitance signal cap11 or cap12 from resonating variable capacitor RVC11 and outputs it as the vibration amplitude signal vib11. The initial-charge signal intchg11 received from the initial charge assurance circuit ICA11 is supplied to the output portion of the CTC11 for preparation for the electricity generating operation to start. The charge transportation circuit CTC11 supplies the output power signal genpll in accordance with the generated power signal genout11. The waveform of the generated power signal genout11 that is generated from the charge transportation circuit CTC11 is not a neat DC waveform. Under ideal conditions where no leakage occurs in the generator device, there is a possibility that generated output voltage becomes so large as to exceed the withstand voltage of the circuits of the generator. Thus, the output control circuit OCC11 keeps the generated power signal genout11 at a constant voltage level and rectifies the signal to stable DC voltage. Moreover, the output control circuit OCC11 generates two types of output signals outsig11 and outsig12: one which is small electric power output to be supplied to the circuits within the generator device because the power output is not large; and the other which is large electric power output for driving a large load. The output control circuit OCC11 has a mechanism to continue to supply the small electric power output and to supply the large electric power output after a certain charging period.

An embodiment of the vibration-to-electric energy generator configured to operate as described above enables conversion of any given vibration energy, like natural vibration, to electric energy. The electricity generating operation starts or halts, depending on the amplitude of vibration energy (amount of energy) and it is assured that sufficient initial charge exists when vibration operation starts. The reference clock signal for the control circuit can be in sync with the cycle of vibration energy and is adaptable to variation in the resonant cycle of the resonating variable capacitor due to manufacturing variance and for other reasons. The phases and pulse widths of pulse signals for control are adjusted to optimum values, according to directly detected output power of the generator device. Generated electric power output is kept at a voltage level and rectified and separated into output for small electric power use and output for large electric power use.

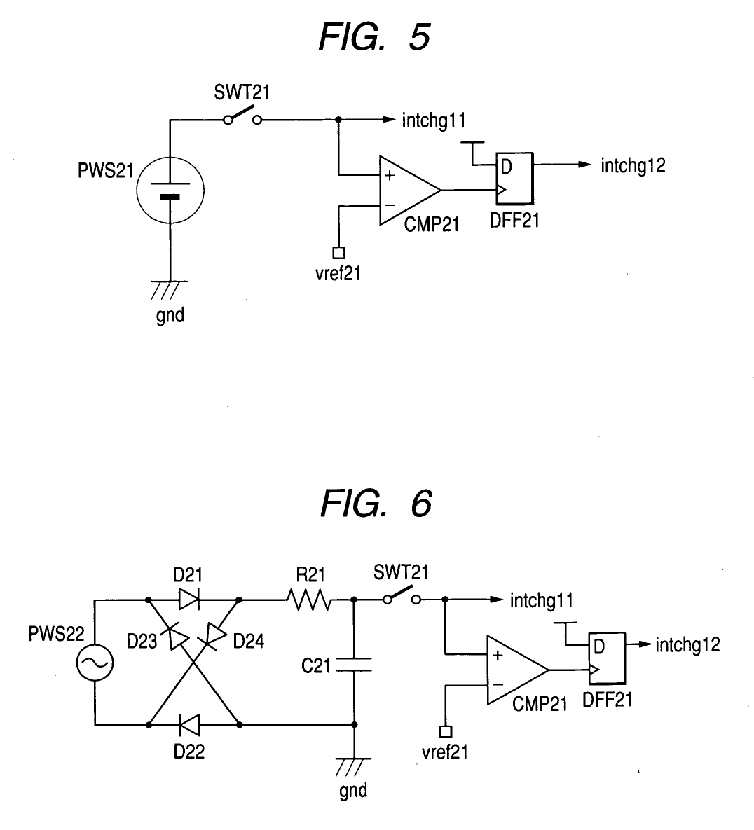

FIG. 5 is a schematic showing an embodiment of the initial charge assurance circuit involved in the present invention. The initial charge assurance circuit includes a power supply PWS21, a switch SWT21, a comparator circuit CMP21, and a D flip-flop DFF21. The power supply PWS21 is connected between ground gnd and the switch SWT21. The switch SWT21 operates to output the output of the power supply PWS21 as the initial-charge signal intchg11 and, at the same time, supply the output to the comparator circuit CMP21. The comparator circuit CMP 21 compares the voltage level of the power supply PWS21 which is supplied via the switch SWT21 with reference voltage vref21, and its output is supplied to a clock signal input of the D flip-flop DFF21. The D flip-flop DFF21 whose D input is connected to the power supply line outputs the initial-charge signal intchg12. The initial-charge signal intchg11 works to supply electric power when the generator device operation starts. At the same time, the electric power is supplied to the D flip-flop DFF21. The power supply PWS21 that functions as the power source may be, for example, a charging power supply which is used when the generator device is put to a shipping test, an outlet, a dry cell, a battery cell, or the like. In addition, a solar cell, an electricity generating device using temperature difference, a fuel cell, or the like can be used. Once the electricity generating operation has started, the switch SWT21 may be turned off to disconnect the power supply PWS21. After the electricity generating operation stops, when the generator restarts, if electricity is stored in a charger, capacitor, or the like connected to the output of the generator device, that electricity can be used as the power supply PWS21. The initial-charge signal intchg12 is used to detect whether the power supply PWS21 holds electricity enough to operate the generator device. If the output voltage of the power supply PWS21 is greater than the reference voltage verf21, the initial-charge signal intchg12 is output. The initial-charge signal intchg12 continues to be output as long as the electricity of the power supply PWS 21, for example, and hence the output voltage of the generator is not less than a given value. This initial charge assurance circuit ensures that electricity generating operation starts and enables the generator device to start, halt, or restart.

FIG. 6 is a schematic showing an embodiment of the initial charge assurance circuit involved in the present invention. In comparison with the initial charge assurance circuit embodiment of FIG. 5, difference lies in a power supply circuit that is formed instead of the power supply PWS 21, and other structures may be the same. The power supply circuit includes a power supply PWS22, diodes D21, D22, D23, D24, a resistor R21, and a capacitor C21. If AC power is supplied to the PWS22 as the power supply, the diodes D21, D22, D23, D24 perform full-wave rectification of the supply voltage, the resistor R21 and capacitor C21 work as a low-pass filter to remove ripple components, and the AC voltage is converted to constant DC voltage. In order to provide the AC power supply PWS22, the following methods may be used, for example: receiving RF signals by an inductor; connecting an AC source to an inductor and receiving AC by inductance coupling; receiving magnetic field fluctuation of a magnet (for example, caused by applying vibration energy to the magnet) and using induced electromotive force; or receiving impulse waves or vibration energy by using a piezo device for generating electricity. Using this circuit configuration, for example, it is possible to start the generator device by RF waves.

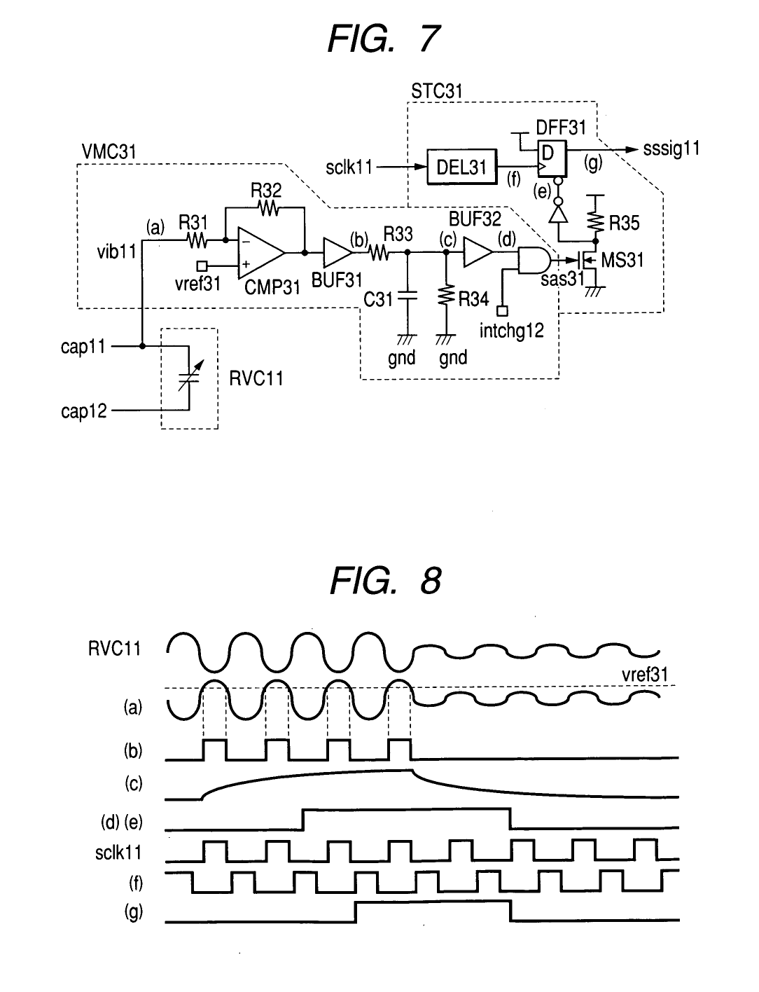

FIG. 7 is a schematic showing an embodiment of the start and halt circuit involved in the present invention. The start and halt circuit includes a vibration amplitude measurement circuit VMC31 and a start timing control circuit STC31. The vibration amplitude measurement circuit VMC31 receives the capacitance signal cap11 from the resonating variable capacitor RVC11 or the vibration amplitude signal vib11, which corresponds to the capacitance signal transferred via the charge transportation circuit CTC11, and the initial-charge signal intchg12, and outputs a start permission signal sas31. The vibration amplitude measurement circuit VMC31 directly detects the amplitude of capacitance fluctuation of the variable capacitor and generates the start permission signal sas31, if the amplitude of capacitance fluctuation is not less than a certain value and sufficient initial charge exists. The detected amplitude of capacitance fluctuation from the resonating variable capacitor RVC11 correlates with given vibration energy. The start timing control circuit STC31 receives the start permission signal sas31 and the reference signal sclk11 and generates the start and halt signal sssig11. Even after the input of the start permission signal sas31, the start and halt signal sssig11 may be output at optimal timing. The start timing control circuit STC31 determines that timing, based on the reference signal sclk11, and generates an actual start and halt signal sssig11.

FIG. 8 is a waveform chart representing the operation of the start and halt circuit. The vibration amplitude measurement circuit VMC31 includes resistors R31, R32, R33, R34, a capacitor C31, a comparator circuit CMP31, buffer circuits BUF31, BUF32, and an AND circuit. The vibration amplitude signal vib11 corresponding to capacitance fluctuation is identified by RVC11 in FIG. 8. For the waveforms shown in FIG. 8, those in the leading half are observed when sufficient vibration is applied and those in the trailing half are observed when small vibration is applied. The vibration amplitude signal vib11 is converted to electric signals through the resistors R31, R32, comparator circuit CMP31, and buffer circuit BUF31. By combination of these components, a voltage at point (a) oscillates as waveform (a). Unless potential fluctuation caused by vibration is greater than the level of the reference voltage vref31 input of the comparator circuit CMP31, no output is generated at point (b). An output pulse (b) is charged gradually through a low-pass filter provided by R33 and C31, which is shown as waveform (c). When the output pulse is lost at (b), that is, when vibration becomes insufficient, charge stored in C31 is discharged through R34 at point (c). As a result, at point (d) or as the start permission signal sas31, a High signal is output during the period when sufficient vibration is applied as shown in FIG. 8. Here, the initial-charge signal intchg12 is assumed to have been given beforehand. If the initial charge to start electricity generating operation is not sufficient and the initial-charge signal intchg12 is not given, the start permission signal sas31 is not generated even if the vibration amplitude is sufficient.

The start timing control circuit STC31 includes a delay circuit DEL31, a D flip-flop circuit DEF31, a resistor R35, a MOS transistor MS31, and an inverter. Depending on the start permission signal sas31, a reset input (e) of the D flip-flop changes. If the initial-charge signal intchg12 is given, signals at points (d) and (e) oscillate correspondingly. That is, if the vibration amplitude is large, the input (e) is unreset; if small, the input (e) is put in the reset state. The reference signal sclk11 is delayed by the delay circuit DEL31 at point (f), which is shown as waveform (f). After the input (e) is unreset, when a delayed signal (f) is input to the D flip-flop, the start and halt signal sssig1 is output at point (g). The timing at which the start and halt signal sssig1 (g) is output is adjusted to come during a half-cycle of capacitance fluctuation RVC11, transition from the minimum to the maximum capacitance. This is because electricity generating operation starts from the moment at which the capacitance of the resonating variable capacitor RVC11 has reached the maximum. A delay time of the delay circuit DEL31 may be predefined by design. Using a designed delay time causes no problem because the half-cycle of RVC11 is relatively long, several tens of ms to 1/10 ms, and its length is sufficiently large even in the light of device manufacturing variance. Alternatively, it may also be preferable that the delay time of the delay circuit DEL 31 can be adjusted manually, using an external input. For example, if the delay circuit is formed by a resistor and capacitor combination, namely, an RC delay, a variable resistor should be used. Or, if the delay time of the delay circuit is determined by the number of stages of digital delay devices, a register by which the number of stages can be adjusted should be used. In this way, the delay can be optimized. If vibration energy becomes so small that output at point (g) is stopped, no consideration should be taken for the timing of the start and halt signal sssig1 and, thus, the same timing as signal (e) may be used.

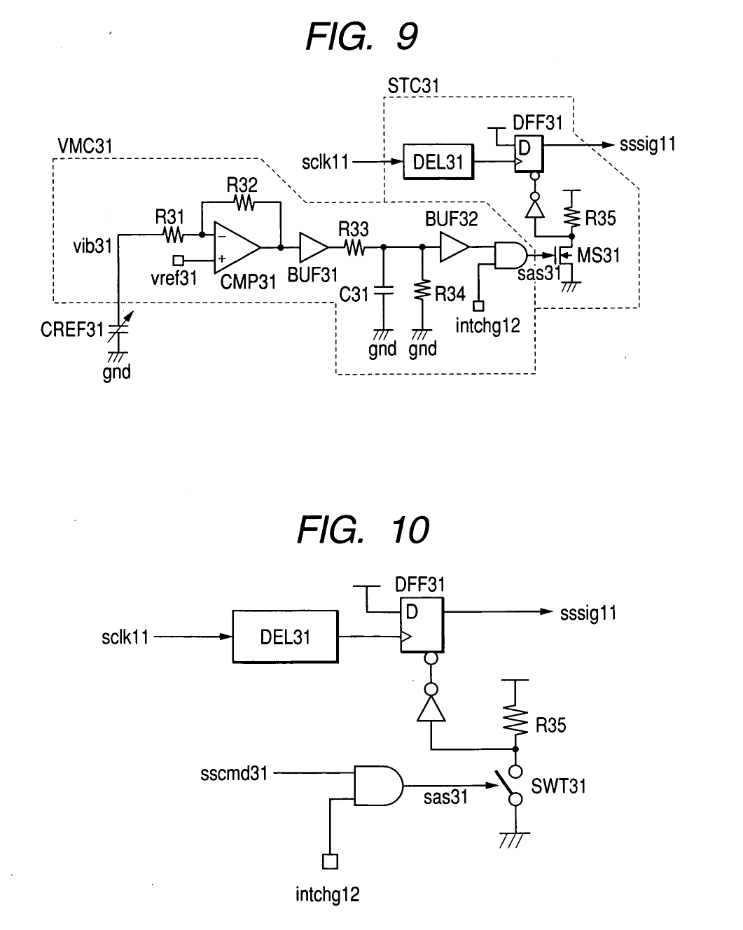

FIG. 9 is a schematic showing an embodiment of a start and halt circuit involved in the present invention. If a reference variable capacitor CREF31 is employed, with its capacitance fluctuating in sync with the resonating variable capacitor RVC11 that is used for generating electricity, the vibration amplitude signal vib31 is obtained from the reference variable capacitor CREF31. Given that, for example, the relevant art example of the resonating variable capacitor shown in FIG. 4 is used, the capacitance between the vibration mass and the still comb SC11 and the capacitance between the vibration mass and the still comb SC12 fluctuate in the same cycles and in sync with each other, but in opposing phases. Using such combination of variable capacitors, it is possible to assign one for generating electricity and the other for reference. The vibration amplitude measurement circuit VMC31 and the start timing control circuit STC31 may be the same as those shown in FIG. 7.

FIG. 10 is a schematic showing an embodiment of a start and halt circuit involved in the present invention. The vibration amplitude measurement circuit is replaced by an AND circuit and start/halt is decided by a start and halt command sscmd31 which is input externally. Alternatively, the MOS transistor MS31 in the start timing control circuit is replaced by a switch SWT31 and start/halt may be decided by directly turning the switch on/off.

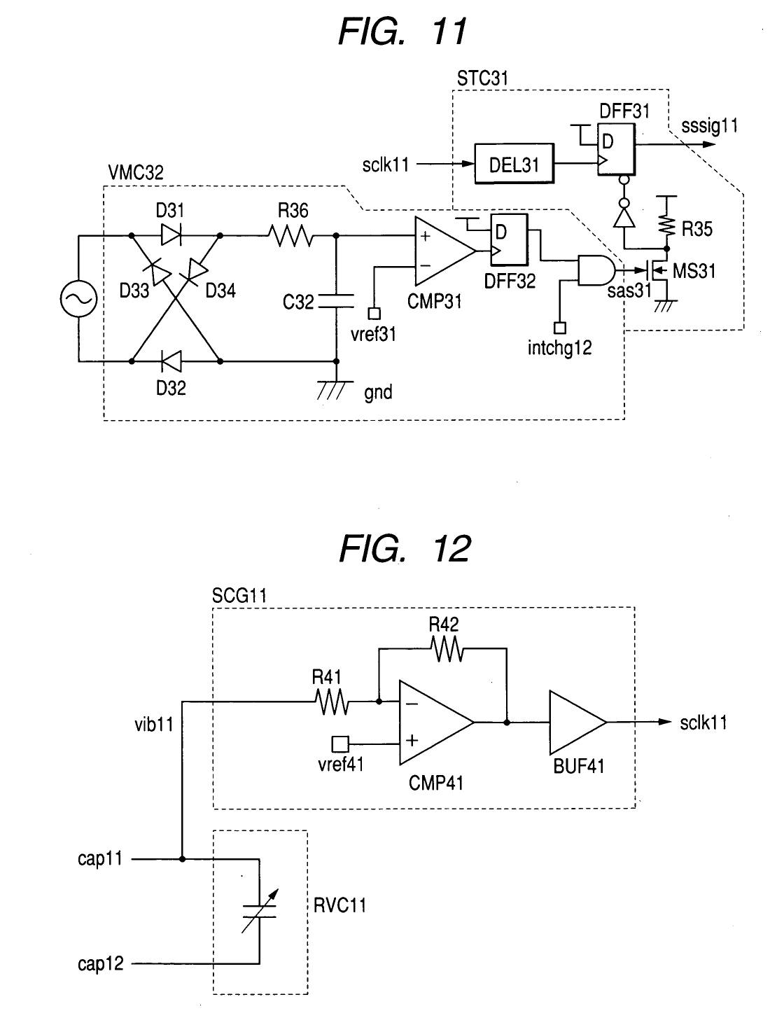

FIG. 11 is a schematic showing an embodiment of the start and halt circuit involved in the present invention. In the start and halt circuit embodiment example of FIG. 11, the vibration amplitude signal vib31 in the embodiment shown in FIG. 9 is replaced. Start/halt is decided depending on a power supply PWS31. The vibration amplitude measurement circuit VMC32 detects the energy amount of this power supply PWS31, decides to start or halt, and generates the start permission signal sas31. For AC signal supplied from the power supply PWS31, diodes D31, D32, D33, D34 perform full-wave rectification of the AC signal, a resistor R36 and a capacitor C32 remove ripples, and the AC signal is converted to DC voltage. This voltage value is compared with the reference voltage Vref31 in the comparator circuit CMP31. After output from the comparator circuit CMP31, the signal processing may be performed as is done in the above embodiments shown in FIGS. 7 and 9; that is, if the energy amount is not less than a certain value, the start permission signal sas31 is output; if the energy amount decreases less than that value, the start permission signal sas31 is not output. Alternatively, as shown in FIG. 11, the circuit may be configured such that the D flop-flip decides to output the start permission signal sas31 and, once decided, this signal continues to be output until all the electric power of the generator is used up. For a system where, once the electricity generating operation has started, it is undesirable to halt it, this configuration should be used. To provide the power supply PWS31, RF waves and inductor, a vibratory magnet and inductor, a piezo device for generating electricity, or the like, may be used. If the magnet is vibrated or vibration is applied to the piezo device, the amplitude of reference vibration is detected separately from the resonating variable capacitor.\

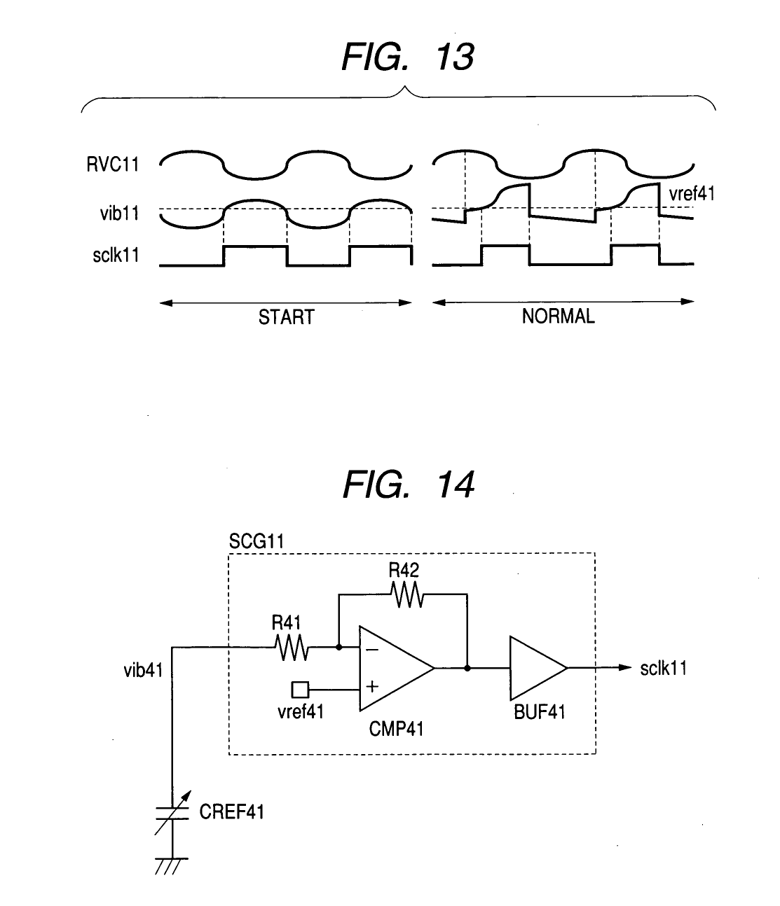

FIG. 12 is a schematic showing an embodiment of the reference clock generator involved in the present invention. The reference clock generator includes resistors R41, R42, a comparator circuit CMP41, and a buffer circuit BUF41. The reference clock generator receives the input of the capacitance signal cap11 from the resonating variable capacitor RVC11 or the vibration amplitude signal vib11, which corresponds to the capacitance signal transferred via the charge transportation circuit CTC11, and the comparator circuit CMP41 compares the voltage of the input signal with a reference signal vref41. The buffer circuit BUF41 amplifies the result of the comparison and outputs it as the reference signal sclk11. FIG. 13 shows waveforms representing the operation of the reference clock generator. The left waveform chart shows the waveforms observed when electricity generating operation starts or halts, and the right waveform chart shows the waveforms observed during the electricity generating operation. RVC11 is the waveform of capacitance fluctuation of the resonating variable capacitor. When the reference clock generator is connected, the waveform vib11 of the vibration amplitude signal oscillates in a phase just opposite to the phase of the capacitance fluctuation waveform, and the reference signal sclk11 is output. Only the vibration amplitude signal vib11 has a different waveform during the electricity generating operation, but other operations may be the same. As is apparent from FIG. 13, the reference signal is generated, with its cycle in sync with the cycle of the capacitance fluctuation, or in other words, in sync with vibration energy, though the phases of differ.

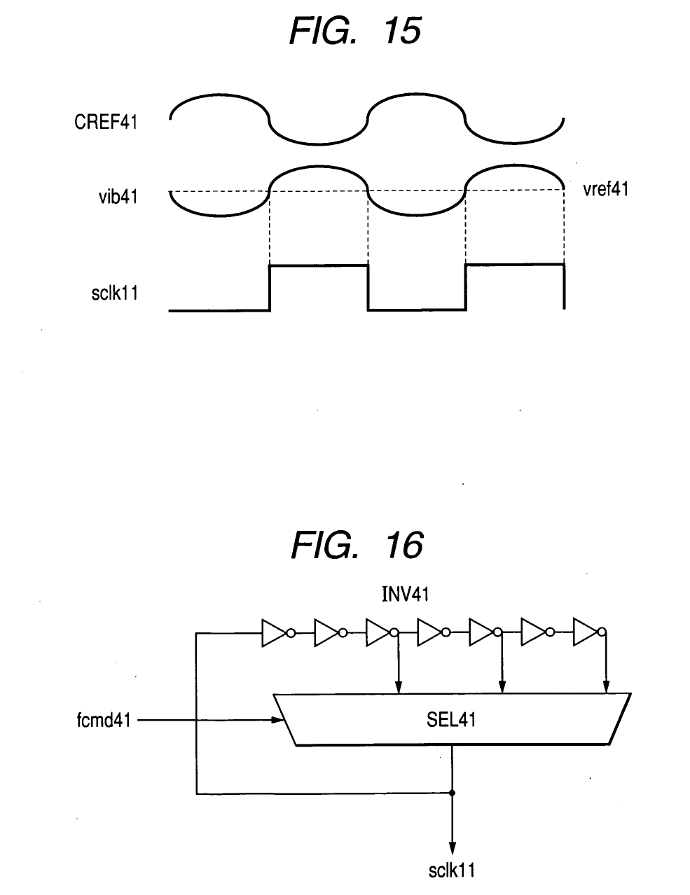

FIG. 14 is a schematic showing an embodiment of the reference clock generator involved in the present invention. In this embodiment, capacitance fluctuation of the resonating variable capacitor is not directly measured, and, instead, a reference variable capacitor CREF41 is measured. In this case, a capacitance signal vib41 has a constant waveform that is easy to detect, like an operating waveform shown in FIG. 15, regardless of start/halt of electricity generating operation.

FIG. 16 is a schematic showing an embodiment of the reference clock generator involved in the present invention. To generate the reference clock, a ring oscillator may be used. In this case, the number of stages of an inverter circuit INV41 should be controlled to meet a required oscillation cycle. Selecting a number of stages is performed by using a selector circuit SEL41. A number of stages to be selected is determined by a frequency control command fcm41. This frequency control command fcm4 may be supplied externally. The frequency control command fcm41 changes the number of stages in accordance with frequency variation of vibration energy, if necessary.

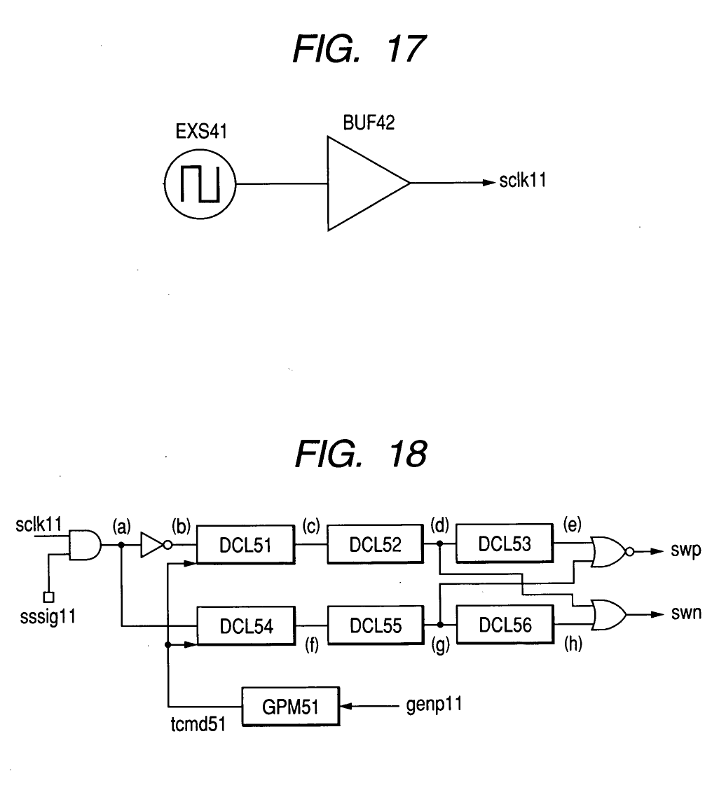

FIG. 17 is a schematic showing an embodiment of the reference clock generator involved in the present invention. In this embodiment, the reference clock generator directly generates the reference signal sclk11, using an external signal source EXS41 and a buffer circuit BUF 42.

FIG. 18 is a schematic showing an embodiment of the pulse generation circuit involved in the present invention. The pulse generation circuit includes logic circuits such as AND, inverter, NOR, and OR, delay control circuits DCL51, DCL52, DCL53, DCL54, DCL55, and an output power measurement circuit GPM51. The pulse cycles, phases, and pulse widths of timing control signals swp/swn are determined through chains of delay control circuits, based on the reference signal sclk11. The start and halt signal sssig11 is assumed to have been given. The output power measurement circuit GPM51 receives the input of the output power signal genp11, determines an optimum delay time of the delay control circuits, and outputs a timing control command tcmd51. Each delay control circuit controls the delay time, according to the timing control command tcmd51.

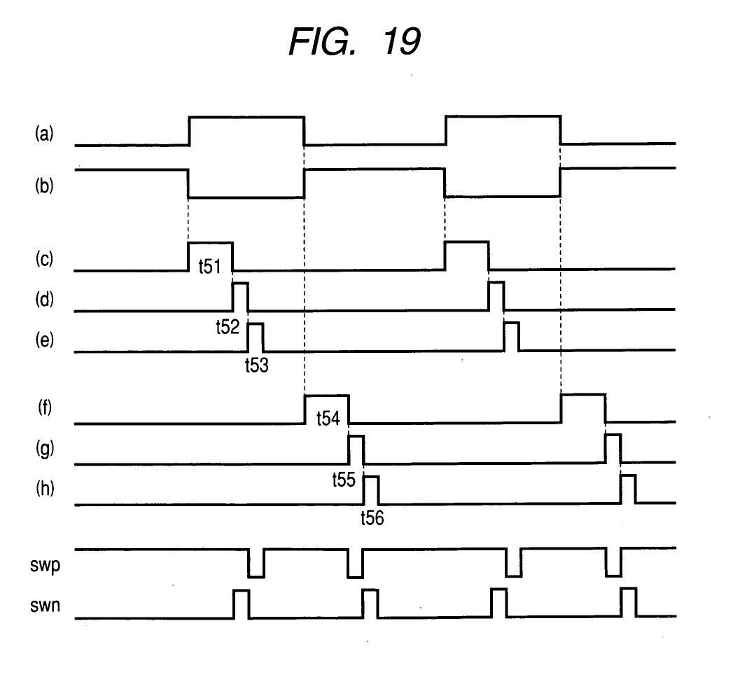

FIG. 19 is a waveform chart of operating waveforms at connection points in the pulse generation circuit of FIG. 18. Waveform (a) is the reference signal sclk11 that is input at point (a). The waveforms of timing control signals swp/swn are also shown in FIG. 19. Here, four pulse of swp/swn signals are generated for one cycle of the reference signal sclk11. Delay control circuits DCL51 and DCL54 determine the phases of the control signals, which are shown in waveforms (c) and (f) respectively. Delay control circuits DCL52 and DCL56 determine the pulse width of the swn signal, which are shown in waveforms (d) and (h), respectively. Delay control circuits DCL53 and DCL55 determine the pulse width of the swp signal, which are shown in waveforms (e) and (g), respectively. As is apparent from FIG. 19, the phases of the pulse signals are determined, based on the leading edge and the trailing edge of the reference signal sclk11. This is favorable for a case where the signals with different duty cycles are used.

FIG. 23 is a schematic showing an embodiment of the pulse generation circuit involved in the present invention. In comparison with the configuration of FIG. 18, signal (b) instead of signal (a) is input to the delay control circuit 51.

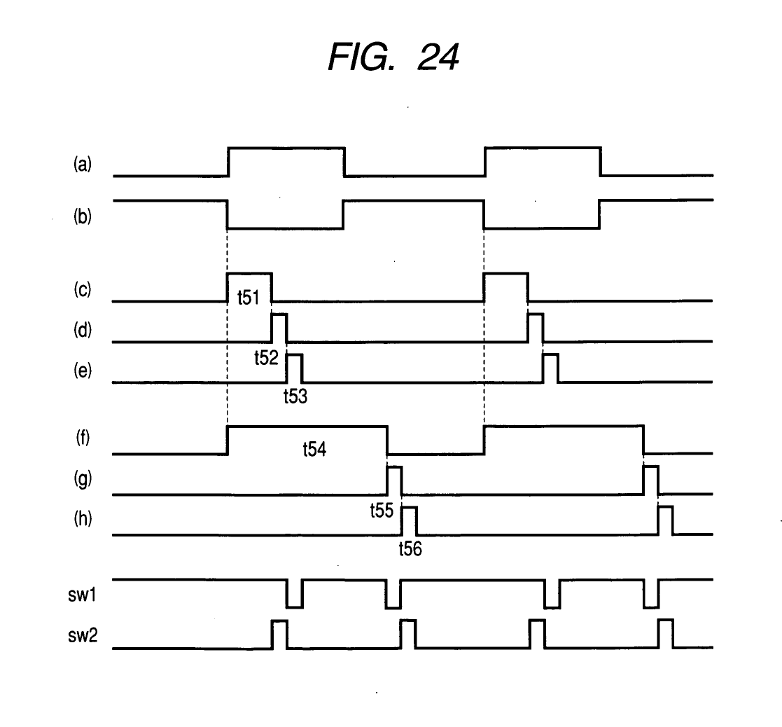

FIG. 24 is a waveform chart representing the operation of the pulse generation circuit of FIG. 23. As is apparent from this waveform chart, the delay control circuit DCL54 makes a delay and generates a pulse so that its leading edge will be in sync with the leading edge of signal (a). This is convenient for a case where the reference signal sclk11 does not output details accurately except cycle.

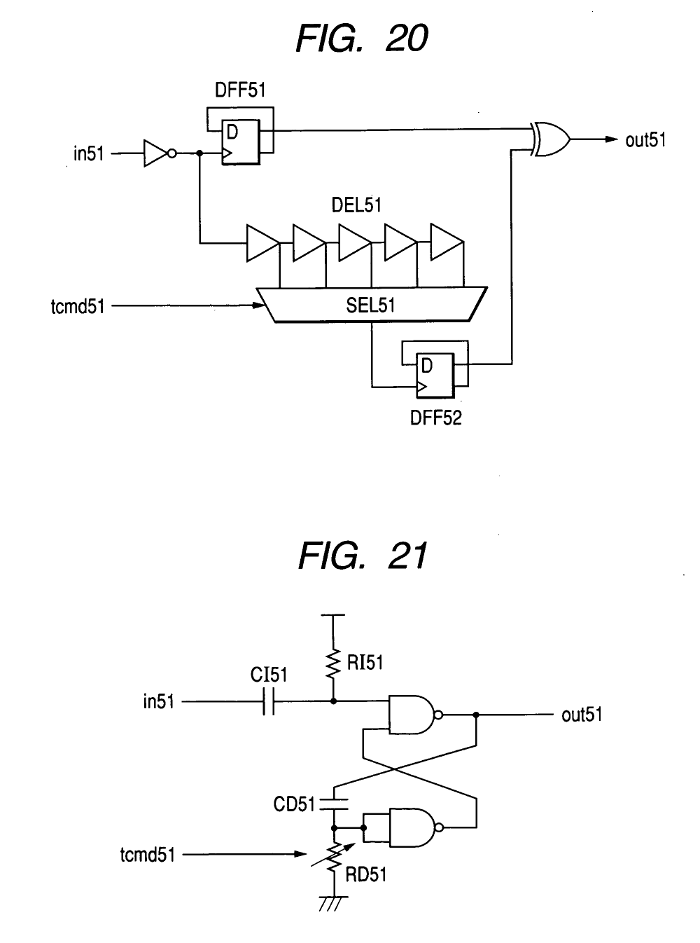

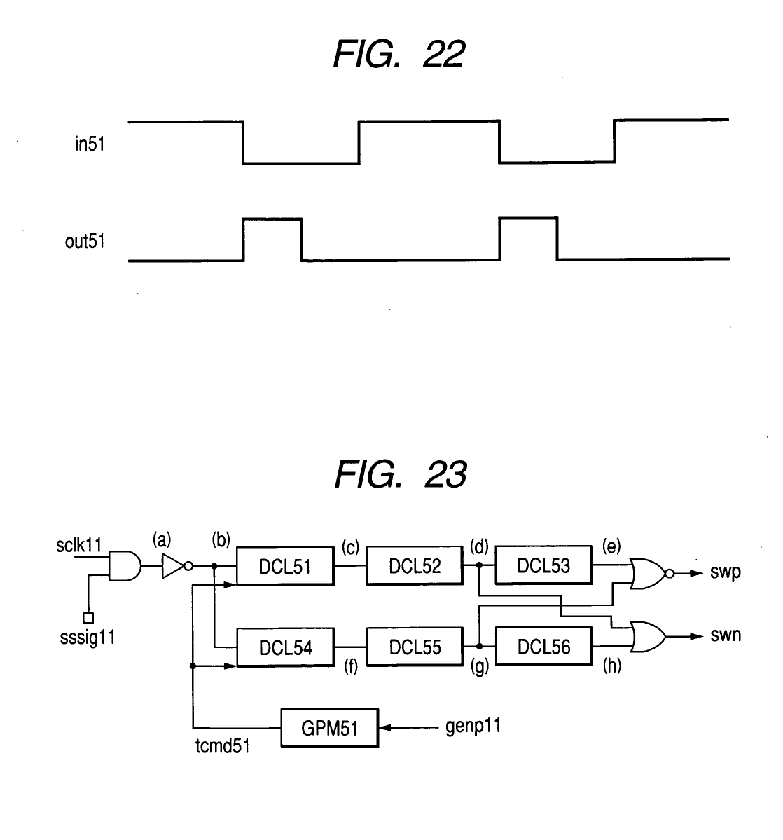

FIG. 20 is a schematic showing an embodiment of a delay control circuit involved in the present invention. The delay control circuit includes logic circuits such as inverter and exclusive OR, D flip-flops DFF51, DFF52, a chain of delay circuits DEL51, and a selector circuit SEL51. A delay time is determined by the number of delay stages of delay circuits DEL51, and the selector circuit SEL51 sends the delay time to the D flip-flop DFF52. The selector selects the number of stages of delay circuits DEL51 under the control of the timing control signal tcmd51. FIG. 22 shows the operating waveforms of input signal in51 and output signal out51. The delay time calculated from the leading edge of the input signal in51 corresponds to the pulse width of the output signal.

FIG. 22 is a waveform chart representing the operation of the delay control circuit of FIG. 20. As shown in FIG. 20, the input clock signal and selector output are frequency divided by the D flip-flops, and thus the delay width can be adjusted, independent of the duty of the input signal, as exemplified by the waveforms shown in FIG. 22.

FIG. 21 is a schematic showing an embodiment of the delay control circuit involved in the present invention. A method of delay control applied in the delay control circuit may be non-digital. The delay control circuit of FIG. 21 has a structure of a single-shot (monopulse) multivibrator. Input and output signal waveforms of this circuit are the same as shown in FIG. 22. Delay time is changed by a variable resistor.

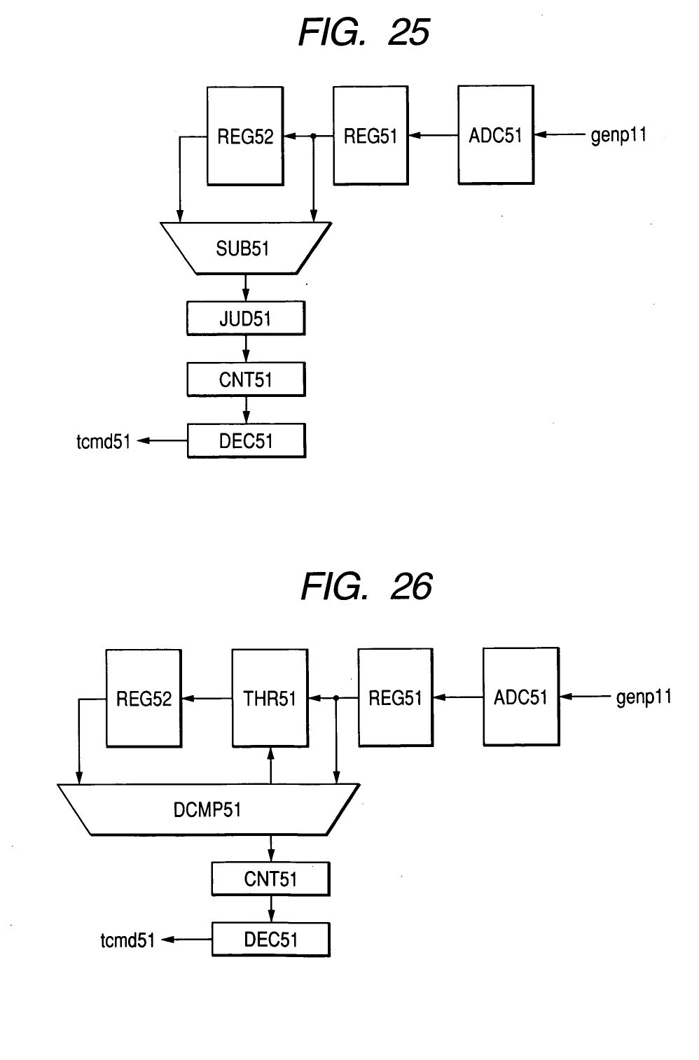

FIG. 25 is a schematic showing an embodiment of the output power measurement circuit involved in the present invention. The output power measurement circuit includes an AD converter ADC51, registers REG51, REG52, a subtracter circuit SUB51, a judgment circuit JUD51, a counter CNT51, and a decoder DEC51. The voltage level of the output power signal genp11 corresponding to the generated power signal genout11 from the charge transportation circuit CTC11 is converted to a digital value by the AD converter ADC51, and the digital value is stored into the register REG51. When a digital value of the voltage of the output power, subsequently generated one cycle later, is obtained, the previous data on the register REG51 is transferred to the register REG52, and the new digital value is stored into the register REG51. For every cycle, subtracter circuit SUB51 and the judgment circuit JUD51 perform comparing new data with the previous output data. As a result, the counter CNT51 and the decoder DEC51 generate the timing control signal tcmd51 to adjust the delay time of delay control circuits in the pulse generation circuit. Eventually, the timing control signal tcmd51 to maximize the output electric power of the generator is supplied. The output power measurement circuit of FIG. 25 is intended to adjust the delay time of one of the delay control circuits in the pulse generation circuit. Or, a timing control signal may be sent to delay control circuits in a corresponding position, such as DCL51 and DCL54. The delay time of delay control circuits, such as DCL52, DCL53, DCL54, DCL55, etc., may be determined individually. The output power measurement is intended to be performed continuously during electricity generating operation. However, if it is desirable to make electricity consumption of the generator as small as possible, the output power measurement circuit may be disconnected as soon as initial measurement is completed.

FIG. 26 is a schematic showing an embodiment of the output power measurement circuit involved in the present invention. In this embodiment, a data-through circuit THRU51 and a digital comparator circuit DCMP 51 are added to the output power measurement circuit embodiment of FIG. 25. If an output power value that is stored in the register REG51 is greater than the previous value stored in the register REG52, the output power value is transferred through the data-through circuit and newly stored into the register REG52. If the output power value is smaller, then the data in the register REG51 is lost without being used.

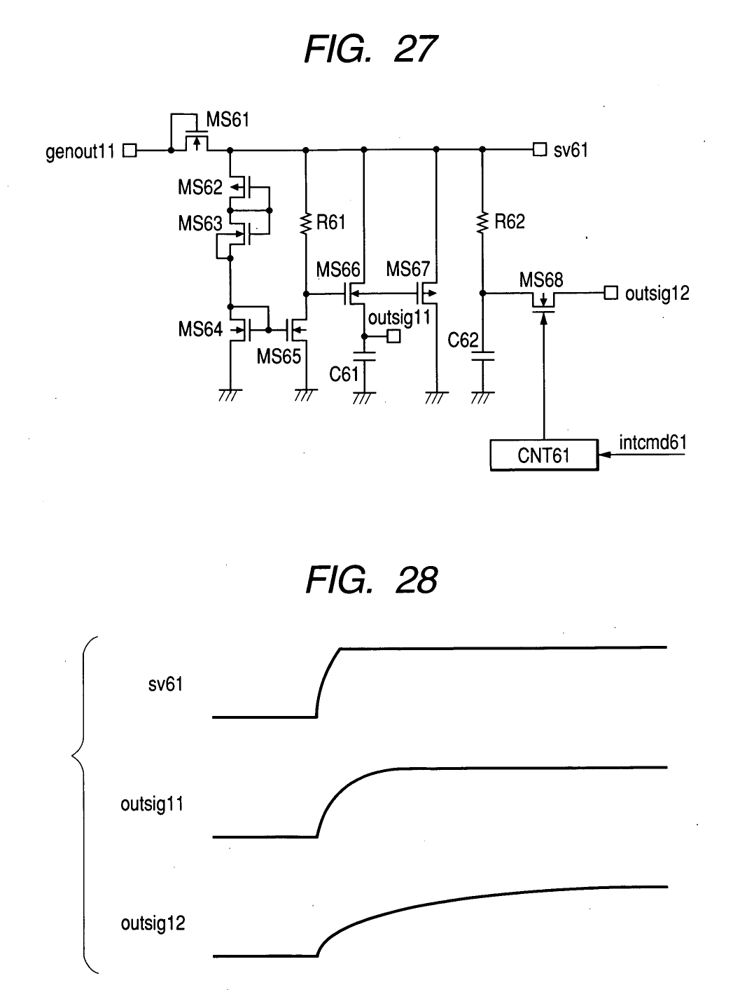

FIG. 27 is a schematic showing an embodiment of the output control circuit involved in the present invention. The output control circuit includes MOS transistors MS61 to MS68, resistors R61, R62, capacitors C61, C62, output signals outsig11, outsig12, and a counter CNT61. The MOS transistors MS62, MS63, MS64, MS65, MS67, and the resistor R61 constitute a Zenar diode structure which restricts the voltage of the generated power signal genout11 to a constant value. The MOS transistor MS66 and the capacitor C61 generate a small electric power output outsig11, whereas the MOS transistor MS68, resistor R62, and capacitor C62 generate a large electric power output outsig12. Because it takes time to charge the large electric power output fully, the counter circuit CNT61 enables the electric power to be used at given time intervals. Operating waveforms are shown in FIG. 28. The waveform of the output outsig11 is comparatively similar to the leading edge of the voltage of the output sv61. It takes time to charge the large electric power output outsig12.

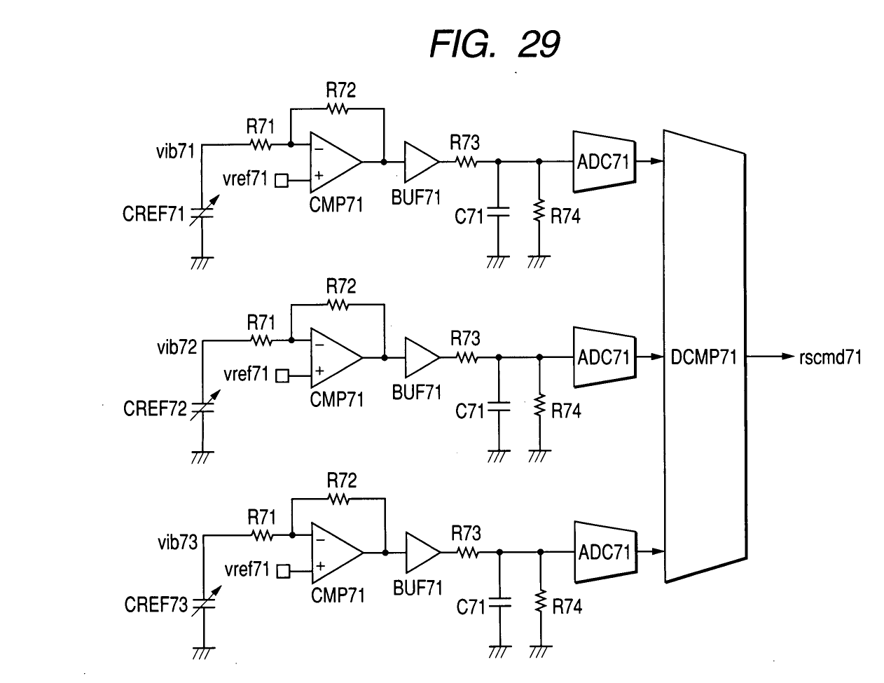

FIG. 29 is a schematic showing an embodiment of a device for variable vibration energy involved in the present invention. When the frequency of vibration varies or when the resonant frequency varies due to manufacturing variance, the device configuration shown in FIG. 29 may be required. The device for variable vibration energy of FIG. 29 is incorporated in the vibration-to-electric energy generator to accommodate a plurality of sources of frequency and nodes. In this device, a plurality of reference capacitors CREF71, CREF72, CREF73 are provided, and vibration to be converted to greatest electric power is detected by a vibration energy detection mechanism.

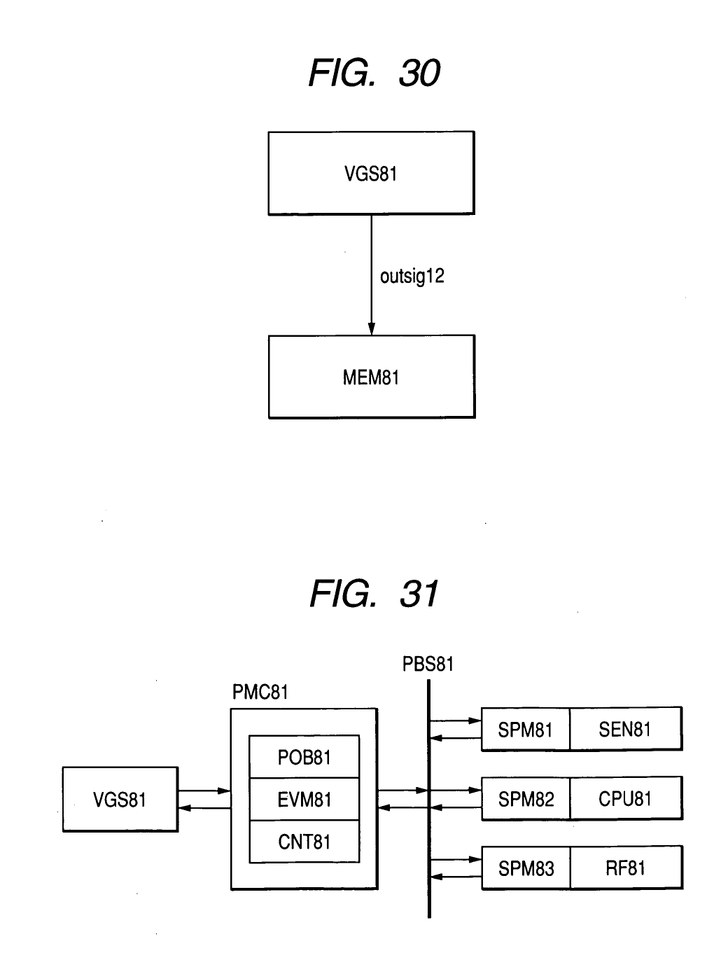

FIG. 30 is a schematic showing an embodiment of a nonvolatile memory to which the present invention can be applied. An example of application of the vibration-to-electric energy generator is shown in FIG. 30. A generator device VGS81 outputs electric power required for a memory 81 as an output signal outsig12 which is supplied to the memory 81. In this way, by supplying electric power to volatile memories such as SRAM and DRAM, these memories can easily be converted to nonvolatile memory.

FIG. 31 is a schematic showing an embodiment of a system with the power generator according to the present invention. This example of the system using the power generator includes a vibration-to-electric energy generator VGS81, an electric power management circuit PMC81, an electric power supply bus PBS81, sub-circuits of electric power management SPM81, SPM82, SPM83, a sensor circuit SEN81, a microcontroller CPU81, and an RF circuit RF81. The electric power management circuit PMC81 includes a power supply monitoring circuit POB81, an event monitoring circuit EVM81, and a counter CNT81. Electric power from the vibration-to-electric energy generator VGS81 is delivered to the electric power supply bus PBS81 through the electric power management circuit PMC81, or is shut off. In the electric power management circuit PMC81, the power supply monitoring circuit POB81 monitors the vibration-to-electric energy generator VGS81 and decides whether to deliver the electric power to the electric power supply bus, according to the generated power. By means of the counter CNT81, the electric power may be delivered at given intervals. Even during this mode of electric power delivery, when the event monitoring circuit EVM81 detects an event occurring, it triggers electric power delivery. The thus delivered electric power is accumulated on the electric power supply bus PBS81 and supplied to a module that needs electricity. Module examples include the sensor circuit SEN81, microcontroller CPU81, and RF circuit RF81. Supplying the electric power to these modules is performed by the sub-circuits of electric power management SPM81, SPM82, SPM83. Based on this illustrative configuration, a system LSI or the like in which the vibration-to-electric energy generator is integrated can be fabricated.

The present invention has industrial applicability with respect to vibration-to-electric energy generators which convert vibration energy to electric energy and, in particular, to vibration-to-electric energy generators using a resonant variable capacitor whose capacitance fluctuates in resonance with vibration energy.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A vibration-to-electric energy generator, comprising:
an initial charge assurance circuit that outputs first and second initial-charge signals;
a start and halt circuit that receives said second initial-charge signal, a vibration amplitude signal, and a reference signal, and that outputs a start and halt signal responsive thereto;
a reference clock generator that receives said vibration amplitude signal and that outputs said reference signal;
a pulse generation circuit that receives said start and halt signal, said reference signal, and an output power signal, and that outputs first and second timing control signals;
a charge transportation circuit that receives said first initial-charge signal, said first and second timing control signals, and first and second capacitance signals, and that outputs said vibration amplitude signal, said output power signal, and a generated power signal;
a resonating variable capacitor that outputs said first and second capacitance signals; and
an output control circuit that receives said generated power signal and that outputs first and second output signals;
wherein said output control circuit delivers electric power obtained from a conversion by said resonating variable capacitor of vibration energy applied thereto to electric energy.

2. The vibration-to-electric energy generator according to claim 1,
wherein said initial charge assurance circuit supplies initial electric power for said vibration-to-electric energy generator to start electricity to said vibration-to-electric energy generator.

3. The vibration-to-electric energy generator according to claim 2,
wherein said initial charge assurance circuit comprises a power supply, a switch, and a comparator circuit,
wherein electric power of said power supply is supplied via said switch to said vibration-to-electric energy generator as said first initial-charge signal, and
wherein said comparator circuit outputs said second initial-charge signal if electric power of said power supply is not less than an electric power required to drive said vibration-to-electric energy generator.

4. The vibration-to-electric energy generator according to claim 1,
wherein said start and halt circuit starts or halts electricity generating of said vibration-to-electric energy generator, and generates said start and halt signal.

5. The vibration-to-electric energy generator according to claim 4,
wherein said start and halt circuit comprises a vibration amplitude measurement circuit and a start timing control circuit,
wherein said vibration amplitude measurement circuit measures an amplitude of vibration that is applied to said resonating variable capacitor to start or halt electricity generating, according to a measured amplitude of the vibration, and
wherein said start timing control circuit generates a command to start or halt the electricity generating based on said vibration amplitude measurement circuit with said start and halt signal in phase with a phase of the vibration.

6. The vibration-to-electric energy generator according to claim 1,
wherein said reference clock generator generates a clock signal in sync with a cycle of the vibration applied to said resonating variable capacitor as said reference signal.

7. The vibration-to-electric energy generator according to claim 1,
wherein said pulse generation circuit generates said timing control signals for control of said charge transportation circuit in sync with said reference signal.

8. The vibration-to-electric energy generator according to claim 7,
wherein said pulse generation circuit comprises at least one delay control circuit and at least one logic circuit, and
wherein the phases and pulse widths of said timing control signals are arbitrarily controllable.

9. The vibration-to-electric energy generator according to claim 8,
wherein said pulse generation circuit includes an output power measurement circuit,
wherein said output power measurement circuit measures a magnitude of electric power of said output power signal and generates a timing control command to optimize the electric power, and
wherein said delay control circuit optimally controls its delay time in accordance with said timing control circuit to optimize electric power of said generated power signal which said charge transportation circuit generates.

10. The vibration-to-electric energy generator according to claim 1,
wherein said output control signal stabilizes the generated power signal which said charge transportation circuit generates and delivers said first and second output signals, according to the electric power and a frequency for electric power usage.

11. The vibration-to-electric energy generator according to claim 10,
wherein said output control circuit stabilizes said generated power signal to keep voltage at approximately a certain value, accumulates first electric power output for a first period and substantially constantly outputs the first electric power output as said first output signal, and accumulates second electric power output, larger than said first electric power output, for a second period which is longer than said first period, and intermittently outputs the second electric power output as said second output signal.

12. The vibration-to-electric energy generator according to claim 1,
wherein said vibration-to-electric energy generator includes a plurality of said resonating variable capacitors with different resonance frequencies, and
wherein one of said resonating variable capacitors which delivers greatest electric energy by converting vibration energy applied to said resonating variable capacitors to electric energy is selected to maximize generated electric power in accordance with a frequency and magnitude of the vibration energy.
